(19) United States
(12) Patent Application Publication
(10) Pub. No.: US 2004/0079523 A1
(43) Pub. Date: Apr. 29, 2004

(54) Vehicle air conditioner

(76) Inventors: Hiroaki Shiraishi, Obu-city (JP); Makoto Umebayashi, Chiryu-city (JP); Yoshinori Yanagimachi, Takahama-city (JP); Tomohiro Inada, Kariya-city (JP)

Correspondence Address: HARNESS, DICKEY & PIERCE, P.L.C., P.O. BOX 828, BLOOMFIELD HILLS, MI, 48303, US

(21) Appl. No.: 10/652,749

(22) Filed: Aug. 29, 2003

(30) Foreign Application Priority Data
Aug. 30, 2002 (JP) 2002-253934
Nov. 22, 2002 (JP) 2002-339243

(51) Int. Cl. B60H 1/00; F24F 11/04; F24F 11/06

(52) U.S. Cl. 165/204; 165/203; 165/247

(57) ABSTRACT

In an initial time of a warming-up control of a vehicle air conditioner, a control unit controls a mode switching member to set a foot mode, a first linear bi-level mode, a fixed bi-level mode, a second linear bi-level mode and the foot mode. In the first and second linear bi-level modes, a face-foot air blowing ratio between air blown from a face opening and air blown from a foot opening is gradually changed as the time passes. Therefore, the face-foot air blowing ratio can be smoothly changed in a mode switching between the foot mode and the fixed bi-level mode. Accordingly, when the mode switching is performed in the warming-up control in the winter, the face-foot air blowing ratio is prevented from being suddenly changed.

### CROSS-REFERENCE TO RELATED APPLICATION

This application is related to and claims priority from Japanese Patent Applications No. 2002-253934 filed on Aug. 30, 2002 and No. 2002-339243 filed on Nov. 22, 2002, the contents of which are hereby incorporated by reference.

### BACKGROUND OF THE INVENTION

1. Field of the Invention

The present invention relates to a vehicle air conditioner which can switch an air outlet mode in a warming-up control.

2. Description of Related Art

Generally, a temperature of water (i.e., engine cooling water), flowing into a heater core of a vehicle air conditioner, is low at a start operation of a vehicle engine in the winter. In order to prevent cool air from being blown into a passenger compartment, operation of a blower is started after a predetermined time passes after the operation of the vehicle engine starts. When the temperature of engine-cooling water increases to a set temperature (e.g., 35° C.) at which heating feeling can be given to a passenger, the operation of the blower is started. Then, as the water temperature increases, an air-blowing amount of the blower is increased. That is, a warming-up control is performed for a predetermined time period after the start of the heating operation.

In U.S. Pat. No. 6,123,267 (corresponding to JP-A-10-157440), in order to improve heating feeling in the warming-up control, a vehicle air conditioner automatically controls an air outlet mode in the following manner. That is, a foot mode, where conditioned air is blown to the foot portion of the passenger, is selected at an initial time of the heating operation in the warming-up control. Then, when the temperature of engine cooling water increases equal to or higher than a predetermined temperature, the air cutlet mode is switched from the foot mode to a bi-level mode where the conditioned air is blown to both of the foot portion and the face portion of the passenger. However, in this warming-up control, the air outlet mode is switched directly from the foot mode to the bi-level mode. Further, the bi-level mode in this warming-up control is not different from a normal bi-level mode that is performed in the intermediate season such as the spring and the autumn. Therefore, the bi-level mode is always performed by an air flow distribution where a flow ratio of air blown toward the face portion is about 50-60% and a flow ratio of air blown toward the foot portion is about 40-50%. When the air outlet mode is switched from the foot mode to the bi-level mode while the air blowing amount increases, a large amount of conditioned air is blown to the face portion of the passenger by one step. Further, at this time, air-blowing noise is readily sensed due to the sudden air blowing toward the face portion of the passenger. When the air outlet mode is switched again from the bi-level mode to the foot mode when the water temperature further increases, the flow of the conditioned air blown toward the face portion of the passenger is suddenly stopped. Accordingly, when the air outlet mode is switched simply between the foot mode and the bi-level mode in the warming-up control, uncomfortable feeling may be given to the passenger.

Further, a face duct is provided to extend from a vehicle floor surface to a vehicle ceiling in a rear air-conditioning unit for a wagon car and the like. The face duct in the rear air-conditioning unit is generally longer than a face duct in a front air-conditioning unit. Thus, in the rear air-conditioning unit, not only an air amount stored in the face duct but also an air amount cooled by the face duct is larger than those in the front air-conditioning unit. Accordingly, when the air outlet mode is switched to the bi-level mode in the rear air-conditioning unit, heating feeling given to the passenger is further deteriorated.

### SUMMARY OF THE INVENTION

In view of the above problems, it is a first object of the present invention to prevent a face-foot air blowing ratio between air blown toward an upper side and air blown toward a lower side of a passenger compartment from being changed suddenly in an air-outlet mode switching between a foot mode and a fixed bi-level mode in a warming-up control in the winter.

It is a second object of the present invention to restrict cool air from being blown to the upper side of a passenger in the passenger compartment in an initial time of a bi-level mode in the warming-up control.

According to the present invention, in a vehicle air conditioner, a mode switching member for opening and closing a face opening and a foot opening is disposed to set at least a foot mode where the mode switching member closes the face opening and opens the foot opening, a fixed bi-level mode where the mode switching member opens both of the face opening and the foot opening by a predetermined fixed air-blowing ratio between air blown from the face opening and air blown from the foot opening, and a linear bi-level mode where an air blowing ratio from the foot opening and an air blowing ratio from the face opening are gradually changed as a time passe. Further, a control unit controls the mode switching member to perform the linear bi-level mode between the foot mode and the fixed bi-level mode, in a warming-up control in which a temperature of air to be blown into the passenger compartment is increased by the heating heat exchanger after a start of a heating operation for heating the passenger compartment. Accordingly, it can prevent the air-blowing ratio between air blown from the face opening and air blown from the foot opening from being suddenly changed.

Specifically, in the linear bi-level mode, an air blowing ratio from the foot opening is reduced and an air blowing ratio from the face opening is increased as a time passe. In this case, the control unit controls the mode switching member to perform the foot mode, the linear bi-level mode and the fixed bi-level mode in this order as the time passes in the warming-up control. Accordingly, variations in the air blowing ratio and in an air-blowing noise due to an air-outlet mode switching from the foot mode to the fixed bi-level mode, can be effectively reduced. Thus, uncomfortable feeling due to the air-outlet mode switching in the warming-up control, can be restricted from being given to the passenger. When the linear bi-level mode is ended, the increase of the air blowing ratio from the face opening is completed. Therefore, it can prevent cool air from being blown to the upper side of a passenger in the initial time of the bi-level mode. Further, in the fixed bi-level mode, conditioned air can be blown to the foot portion and the upper portion of the passenger while the air blowing ratio is maintained at a state where the increase of the air blowing amount from the face opening is completed. Accordingly, in the fixed bi-level mode, the whole body of the passenger can be effectively warmed.

Preferably, the mode switching member is disposed to further set an another linear bi-level mode in which the air blowing ratio from the foot opening is increased while the air blowing ratio from the face opening is reduced, as compared with the fixed bi-level mode, as the time passes. In this case, the control unit controls the mode switching member to perform the another linear bi-level mode and the foot mode in this order after the fixed bi-level mode is performed. Accordingly, the air-outlet mode change from the fixed bi-level mode to the foot air outlet mode can be smoothly performed through the another bi-level mode. Accordingly, the air-blowing ratio between the upper and lower sides of the passenger compartment can be smoothly changed, and air blowing noise can be gradually changed. Accordingly, air-conditioning feeling given to the passenger can be further improved.

### BRIEF DESCRIPTION OF THE DRAWINGS

Additional objects and advantages of the present invention will be more readily apparent from the following detailed description of preferred embodiments when taken together with the accompanying drawings, in which:

FIG. 1 is a schematic diagram showing a vehicle air conditioner with a rear air-conditioning unit, according to a first embodiment of the present invention;

FIG. 2 is a schematic perspective view showing a mounted state of the rear air-conditioning unit on a vehicle at its rear portion, according to the first embodiment;

FIG. 3 is a flow diagram showing a control process of an air-conditioning control unit (ECU) according to the first embodiment;

FIG. 4 is a characteristic graph showing determination of a hot water temperature Tw at step S130 in FIG. 3;

FIG. 5 is a characteristic graph showing determination of a rear inside air temperature Trr at step S140 in FIG. 3;

FIG. 6 is a characteristic graph showing determination of a rear target blowing temperature TAOr at step S150 in FIG. 3;

FIG. 7 is a characteristic graph showing a relationship between an outside air temperature Tam and a timer time t1 at step S160 in FIG. 3;

FIG. 8 is a characteristic graph showing a relationship between the outside air temperature Tam and a timer time t2 at step S180 in FIG. 3;

FIG. 9 is a characteristic graph showing a normal air-outlet control based on a target blowing temperature TAO (TAOr);

FIG. 10 is a characteristic graph showing a relationship between an air outlet mode and a time in a warming-up control, according to the first embodiment;

FIG. 11 is a characteristic graph showing a relationship between an air outlet mode and a time in a warming-up control, according to a second embodiment of the present invention;

FIG. 12 is a characteristic graph showing a relationship between an air outlet mode and a time in a warming-up control, according to a third embodiment of the present invention;

FIG. 13 is a characteristic graph showing a relationship between an air outlet mode and a time in a warming-up control, according to a fourth embodiment of the present invention;

FIG. 14 is a schematic perspective view showing an arrangement position of a rear air-conditioning unit in a vehicle rear portion according to a fifth embodiment of the present invention;

FIG. 15 is a schematic plan view showing the vehicle in which a vehicle air conditioner of the fifth embodiment is mounted;

FIG. 16 is a partially sectional view showing ceiling air outlets and a ceiling air passage according to the fifth embodiment;

FIG. 17 is a characteristic graph showing determination of the rear target blowing temperature TAOr at step S150 in FIG. 3, according to a modification of the present invention; and

FIG. 18 is a characteristic graph showing a relationship between the outside air temperature Tam and a threshold temperature TG for the rear target blowing temperature TAOr in FIG. 17.

### DETAILED DESCRIPTION OF THE PRESENTLY PREFERRED EMBODIMENTS

Preferred embodiments of the present invention will be described hereinafter with reference to the appended drawings.

### First Embodiment

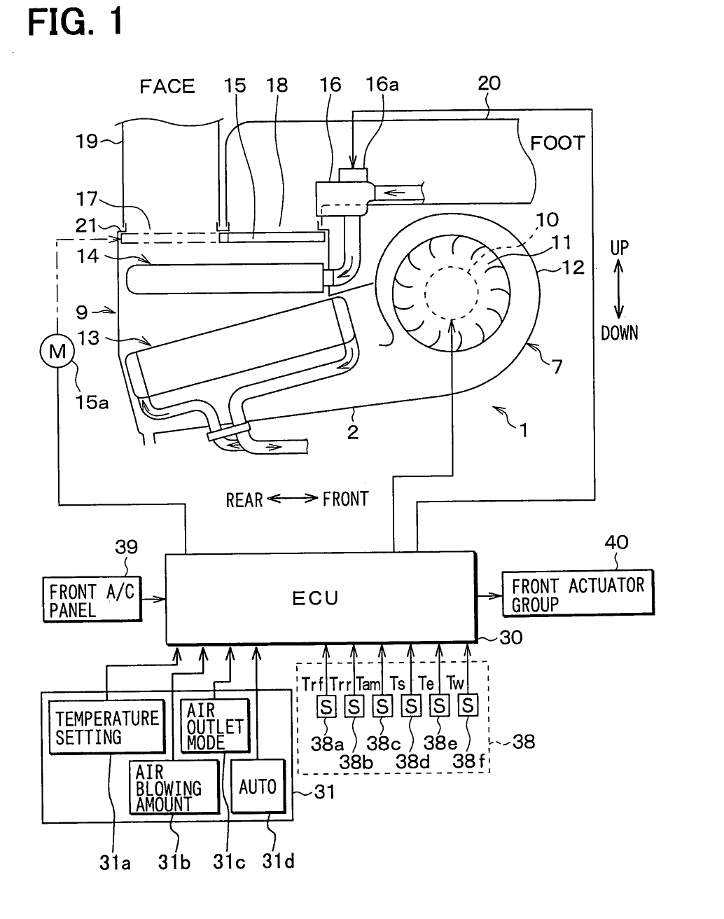

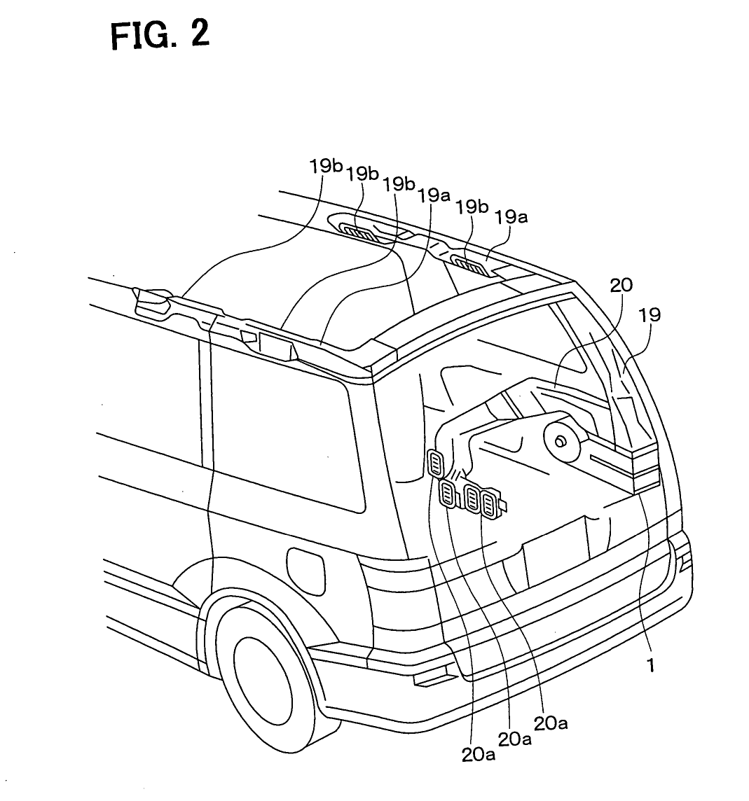

The first embodiment of the present invention will be now described with reference to FIGS. 1-10. In the first embodiment, the present invention is typically applied to a rear air conditioning unit 1 of a vehicle air conditioner. As shown in FIG. 1, the rear air-conditioning unit 1 includes an air-conditioning case 2 made of a resin material (e.g., polypropylene). The air-conditioning case 2 is constructed with plural separated case parts that are integrally assembled together to form an air passage therein. The rear air-conditioning unit 1 includes a blower 7, and a heat-exchanging unit 9 having a cooling portion and a heating portion that are integrated together. In FIG. 2, the rear air-conditioning unit 1 is provided in a vehicle side wall around a rear floor surface in a cargo room of a wagon car, such that the blower 7 is positioned on a vehicle front side and the heat-exchanging unit 9 is positioned on a vehicle rear side from the blower 7. The blower 7, for blowing air toward a rear seat area of a passenger compartment, includes a fan driving motor 10, a centrifugal multi-blade fan 11 connected to a rotation shaft of the fan driving motor 10, and a scroll case 12 for accommodating the fan 11.

The heat-exchanging unit 9 is disposed downstream from the blower 7, and includes an evaporator 13 at the lower side. The evaporator 13 is a cooling heat exchanger, and is connected to a compressor driven by a vehicle engine (not shown) and the like to construct a refrigerant cycle. In the evaporator 13, low-pressure refrigerant flowing therein absorbs heat from air, thereby cooling the air. A heating heat exchanger 14 is disposed downstream of the evaporator 13. In the first embodiment, the heating heat exchanger 14 is disposed above the evaporator 13, and heats air by using hot water (engine-cooling water) of the vehicle engine as a heat source.

The air-conditioning case 2 has a face opening 17 and a foot opening 18 on an upper surface 21. Both of the openings 17, 18 are provided above (downstream of) the heating heat exchanger 14 so as to opposite to the heating heat exchanger 14. Conditioned air is blown from the face opening 17 to the upper half body (face portion) of a passenger on the rear seat in the passenger compartment, and is blown from the foot opening 18 to the foot portion of the passenger. An air-outlet mode switching door 15, for opening and closing the openings 17, 18, is disposed upstream of both the openings 17, 18. The air-outlet mode switching door 15 is a slide mode switching door disposed below the openings 17, 18 to approximately horizontally slide (reciprocate) on an opening surface of both the openings 17, 18 of the air conditioning case 2. Therefore, the air-outlet mode switching door 15 can move along the opening surface of the openings 17, 18 of the air conditioning case 2 between a foot open position indicated by the solid line and a face open position indicated by the dashed line in FIG. 1.

One end (lower end) of a face duct 19 is connected to the face opening 17. The other end of the face duct 19 extends to a vehicle ceiling, and is branched into right and left sides to form air outlet ducts 19a having plural face outlets 19b, as shown in FIG. 2. Conditioned air after being thermal-adjusted is blown from the plural face outlets 19b to the upper half body of the passenger on the rear seat in the passenger compartment. One end of a foot duct 20 is connected to the foot opening 18. As shown in FIG. 2, the other end of the foot duct 20 extends along a vehicle right side wall obliquely to a vehicle front lower side, and forms plural foot outlets 20a. Conditioned air is blown from the plural foot outlets 20a to the foot portion of the passenger on the rear seat. In FIG. 2, the plural foot outlets 20a are provided such that the conditioned air is blown from the vehicle right side wall toward the left side in the passenger compartment. Further, in the vehicle air conditioner, a front air-conditioning unit (not shown) is provided in a dashboard (not shown) positioned on the front side in the passenger compartment. The front air-conditioning unit has a structure similar to the rear air-conditioning unit 1.

Next, an electronic control portion in the vehicle air conditioner according to the first embodiment will be now described. An air-conditioning control unit (ECU) 30, for controlling the front air-conditioning unit and the rear air-conditioning unit 1 is constructed with a microcomputer and its peripheral circuit. The microcomputer includes a central processing unit (CPU), a read only memory (ROM), a random access memory (RAM) and the like. A control program used for air-conditioning control is stored in the ROM of the ECU 30, and various calculations and processing are performed based on the control program. Sensor signals from an air-conditioning sensor group 38 and operation signals from a front air-conditioning panel 39 and a rear air-conditioning panel 31 are input to an input portion of the ECU 30. The air-conditioning sensor group 38 includes various sensors 38a-38f for detecting a front inside air temperature Trf, a rear inside air temperature Trr, an outside air temperature Tam, a solar radiation amount Ts, a post-evaporator air temperature Te, a hot water temperature Tw and the like.

The front air-conditioning panel 39, provided as an operation member, is disposed around the dashboard on a front side of a driver seat. The ECU 30 drives a front actuator group 40 by using the predetermined control program based on the operation signals from the front operation members of the front air-conditioning panel 39 and the sensor signals from the air-conditioning sensor group 38 input to the ECU 30. On the other hand, the rear air-conditioning panel 31 is disposed around a rear seat area in the passenger compartment. A rear temperature setting switch 31a provided in the rear air-conditioning panel 31 outputs a temperature setting signal of the rear seat area in the passenger compartment. A rear air-blowing amount switch 31b is provided in the rear air-conditioning panel 31 for manually switching an air-blowing amount of the rear blower 7, and is used to turn on and turn off the rear blower 7. An air-outlet mode switch 31c outputs an air-outlet mode setting signal for manually setting a rear air outlet mode, among a face mode, a bi-level mode and a foot mode.

In the face mode, the air-outlet mode switching door 15 is operated to entirely open the rear face opening 17 and to close the rear foot opening 18. Therefore, in the face mode, conditioned air is blown only from the rear face outlets 19b to the upper half body of the passenger on the rear seat. In the bi-level mode, both of the rear face opening 17 and the rear foot opening 18 are opened by the air-outlet mode switching door 15. When both of the rear face opening 17 and the rear foot opening 18 are opened respectively by an approximate half opening degree, approximate the same amount of conditioned air is blown from both of the openings 17, 18 toward the upper half body and the foot portion of the passenger on the rear seat, in the bi-level mode. In the foot mode, the rear face opening 17 is closed, and the rear foot opening 18 is entirely opened. Therefore, conditioned air is blown from the rear foot outlets 20a to the foot portion of the passenger on the rear seat. An automatic switch 31d in the rear air-conditioning panel 31 switches a control mode of the rear air-conditioning unit 1 between an automatic control mode and a manual control mode.

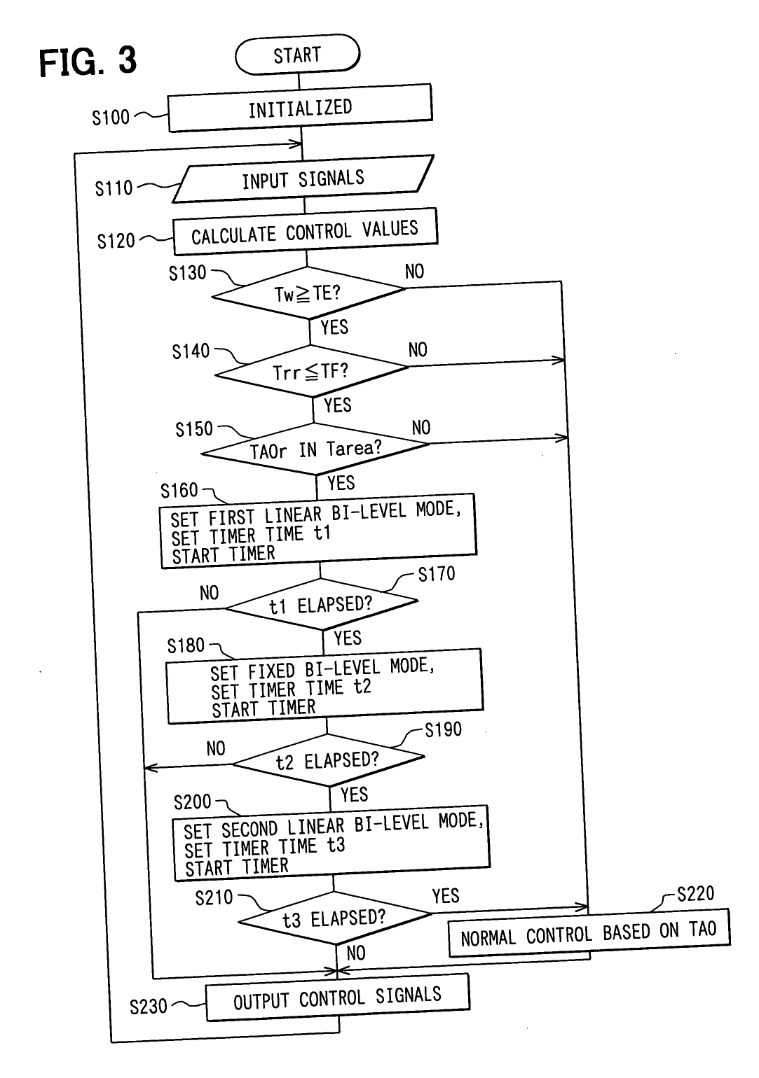

Next, control operation of the rear air-conditioning unit 1 according to the first embodiment will be now described. FIG. 3 shows a control program performed by the ECU 30. When an ignition switch of the vehicle engine is turned on and the automatic switch 31d of the operation member on the rear air-conditioning panel 31 is turned on, the control program shown in FIG. 3 is started. First, control flags, various timers and the likes are initialized at step S100. At step S110, signals are input to the ECU 30, and are stored in the RAM of the ECU 30. Here, the signals include the operation signals from the rear air-conditioning panel 31 and the sensor signals from the air-conditioning sensor group 38 for detecting the vehicle environment conditions relative to the air-conditioning of the passenger compartment.

At step S120, a target temperature of air to be blown to the rear seat area in the passenger compartment, that is, a rear target blowing temperature TAOr is calculated in accordance with the following formula (1) based on the signals input to the ECU 30.

TAOr=Kset×Tsetr−Kr×Trr−Kam×Tam−Ks×Ts+C (1)

wherein, Tsetr is a rear set temperature set by the rear temperature setting switch 31a, Trr is a rear inside air temperature detected by a rear inside temperature sensor 38b, Tam is an outside air temperature detected by an outside temperature sensor 38c, Ts is a solar radiation amount detected by a solar radiation sensor 38d, Kset, Kr, Kam, Ks are gain values, and C is a correction constant.

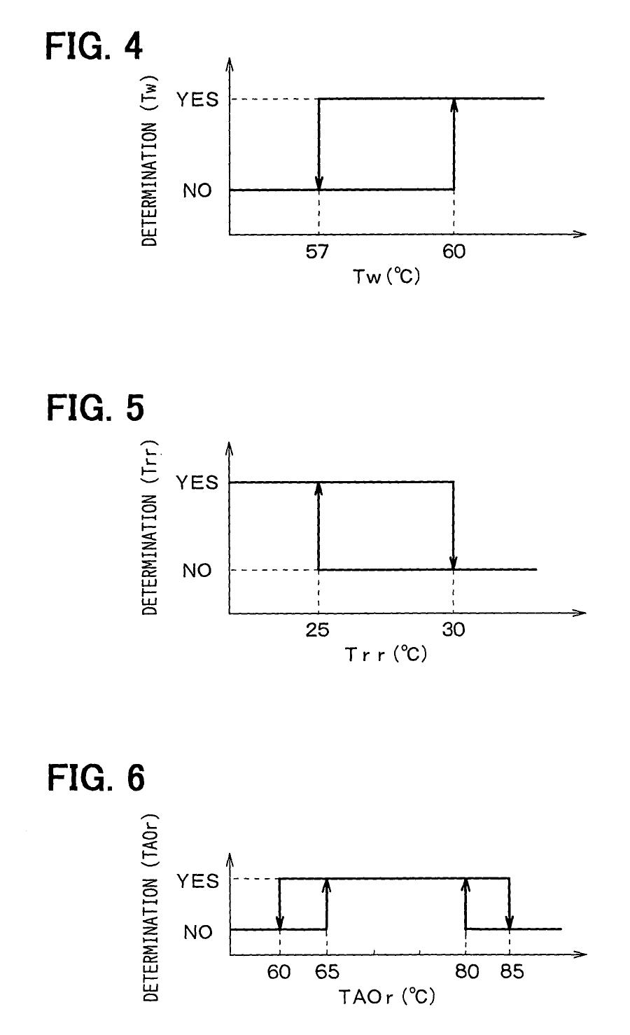

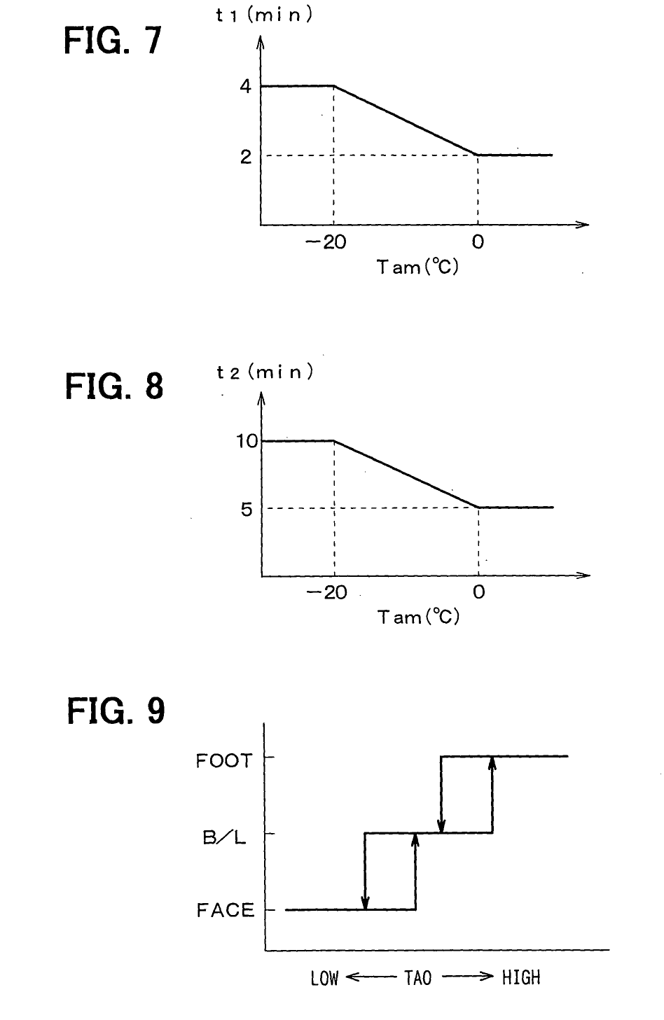

At step S130, as shown in FIG. 4, it is determined whether the water temperature Tw flowing into the heating heat exchanger 14 is equal to or higher than a predetermined temperature TE. When it is determined at step S130 that the hot water temperature Tw is equal to or higher than the predetermined temperature TE, that is, when the determination at step S130 is YES, the control program proceeds to step S140. At step S140, as shown in FIG. 5, it is determined whether the rear inside air temperature Trr detected by the rear inside temperature sensor 38b is equal to or lower than a predetermined temperature TF. When it is determined at step S140 that the rear inside air temperature Trr is equal to or lower than the predetermined temperature TF, that is, when the determination at step S140 is YES, the control program proceeds to step S150. At step S150, as shown in FIG. 6, it is determined whether the rear target blowing temperature TAOr is in a predetermined temperature area Tarea. When it is determined at step S150 that the rear target blowing temperature TAOr is in the predetermined temperature area Tarea, that is, when the determination at step S150 is YES, the control program proceeds to step S160. At step S160, a first linear bi-level mode is set, and a timer time t1 is set in accordance with the outside air temperature Tam as shown in FIG. 7. Then, the counting of the timer time t1 is started.

At step S170, it is determined whether the counting of the timer time t1 is ended. When it is determined at step S170 that the counting of the timer time is not ended, that is, when the determination at step S170 is NO, the control program proceeds to step S230, and the first linear bi-level mode is continued. When it is determined at step S170 that the counting of the timer time t1 is ended, that is, when the determination at step S170 is YES, the first linear bi-level mode is ended, and the control program proceeds to step S180. At step S180, a fixed bi-level mode is set, and a timer time t2 is set in accordance with the outside air temperature Tam as shown in FIG. 8. Then, the counting of the timer time t2 is started. At step S190, it is determined whether the counting of the timer time t2 is ended. When it is determined at step S190 that the counting of the timer time is not ended, that is, when the determination at step S190 is NO, the control program proceeds to step S230, and the fixed bi-level mode is continued. When it is determined at step S190 that the counting of the timer time t2 is ended, that is, when the determination at step S190 is YES, the fixed bi-level mode is ended, and control program proceeds to step S200. At step S200, a second linear bi-level mode is set, and a timer time t3 is set. Then, the counting of the timer time t3 is started.

At step S210, it is determined whether the counting of the timer time t3 is ended. When it is determined at step S210 that the counting of the timer time t3 is not ended, that is, when the determination at step S210 is NO, the control program proceeds to step S230, and the second linear bi-level mode is continued. When it is determined at step S210 that the counting of the timer time t3 is ended, that is, when the determination at step S210 is YES, or when the determination at one of steps S130, S140, S150 is NO, the control program proceeds to S220. At step S220, as shown in FIG. 9, a normal air-outlet mode control is performed based on the rear target blowing temperature TAOr. When the determination at one of steps S170, S190, S210 is NO, or after the control at step S220 is performed, the control program proceeds to step S230. At step S230, the ECU 30 drives an actuator 15a in accordance with the air outlet mode set in each step, so as to move the air-outlet mode switching door 15 to a predetermined position. At this time, the ECU performs automatic air-conditioning control by controlling a voltage applied to the blower motor 10, an actuator 16a for controlling a hot-water flowing amount and the like based on the rear target blowing temperature TAOr and the like.

Next, operation characteristics and advantages according to the first embodiment will be described. First, conditions for setting the first linear bi-level mode or the fixed bi-level mode, will be described in detail with reference to FIGS. 4-6.

In a case where the hot water temperature Tw is equal to or lower than a predetermined low temperature (e.g., Tw=20° C.), if the first liner bi-level mode or the fixed bi-level mode is performed, the following problem is caused. That is, when the hot water temperature Tw is lower than the predetermined low temperature, a temperature of the heating heat exchanger 14 does not sufficiently increase. Therefore, cool air is blown from the face outlets 19b to the upper half body of the passenger, so that uncomfortable feeling is given to the passenger. Thus, when the first linear bi-level mode or the fixed bi-level mode is performed, the hot water temperature Tw is required to be equal to or higher than the predetermined temperature TE (e.g., 60° C.), as shown in FIG. 4. The predetermined temperature TE is set higher than a human body temperature so that warm air can be blown to the passenger. FIG. 4 plots the hot water temperature Tw as the abscissa and the determination (YES, NO) of the water temperature Tw at step S130 as the ordinate. Here, since the hot water temperature Tw, detected by the water temperature sensor 38f, fluctuates around the predetermined temperature TE, hunting may be caused in the air-outlet mode control. Accordingly, as shown in FIG. 4, a hysteresis width of 3° C. is provided in the determination of the water temperature Tw in order to prevent this hunting.

In a case where the rear inside air temperature Trr is equal to or higher than a predetermined temperature (e.g., Trr=35° C.), if the first liner bi-level mode or the fixed bi-level mode is performed, warm air is blown to the upper half body of the passenger. Therefore, hot feeling may be given to the face portion of the passenger, and uncomfortable feeling is given to the passenger. Thus, as a condition for performing the first linear bi-level mode or the fixed bi-level mode, the rear inside air temperature Trr is required to be equal to or lower than the predetermined temperature TF (e.g., 25° C.) as shown in FIG. 5. The predetermined temperature TF is set for determining whether warm air is required for the passenger. Generally, the predetermined temperature TF at step S140 is set equal to or lower than a temperature of 30° C. to be fitted to the human feeling. FIG. 5 plots the rear inside air temperature Trr as the abscissa and the determination (YES, NO) of the Trr at step S140 as the ordinate. Here, as shown in FIG. 5, a hysteresis width of 5° C. is provided in the determination of the rear inside air temperature Trr, to prevent the hunting in the air-outlet mode control.

In a case where the rear target blowing temperature TAOr is outside the predetermined temperature area Tarea , if the first liner bi-level mode or the fixed bi-level mode is performed, the following problem is generated. In a normal air-outlet amount control performed based on a target blowing temperature TAO, when the target blowing temperature TAO is high, a large amount of conditioned air is blown into the passenger compartment. Therefore, for example, when the rear target blowing temperature TAOr is higher than the predetermined temperature area (e.g., TAOr=90° C.), a large amount of warm air is blown to the upper half body of the passenger, so that uncomfortable feeling is given to the passenger. On the other hand, when the rear target blowing temperature TAOr is lower than the predetermined temperature area (e.g., TAOr=50° C.), if warm air is blown to the upper half body of the passenger, hot feeling is given to the face portion of the passenger, and uncomfortable feeling is given to the passenger.

Thus, as the condition for performing the first linear bi-level mode or the fixed bi-level mode, the rear target blowing temperature TAOr is required to be in the predetermined temperature area. FIG. 6 plots the rear target blowing temperature TAOr as the abscissa and the determination (YES, NO) of the rear target blowing temperature TAOr at step S150 as the ordinate. Here, as shown in FIG. 6, hysteresis width of 5° C. are provided for the upper limit and the lower limit of the predetermined range of the rear target blowing temperature TAOr, to prevent the hunting in the air-outlet mode control.

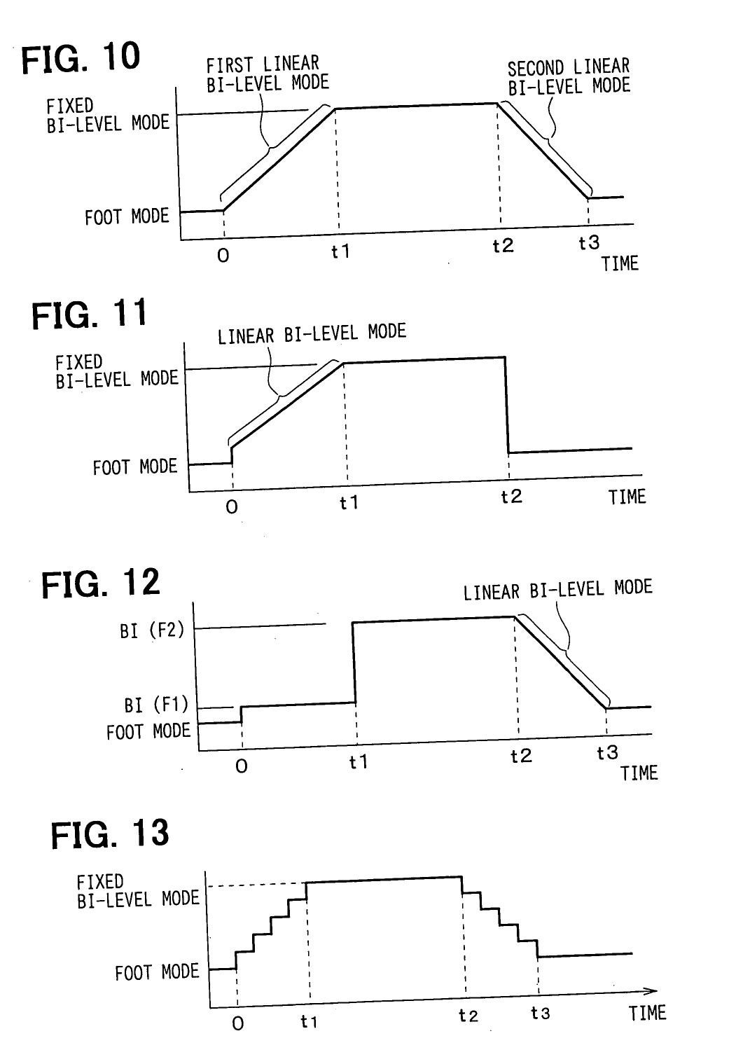

Next, operation times of the first linear bi-level mode, the second linear bi-level mode and the fixed bi-level mode will be described in detail with reference to FIGS. 7-10. As shown in FIG. 10, the air outlet mode is changed as the operation time of the warming-up control passes. The air outlet mode in FIG. 10 indicates an air blowing ratio (face-foot air blowing ratio) between air blown from the face opening 17 and air blown from the foot opening 18. Specifically, at the position of the foot mode in FIG. 10, the air blowing ratio from the face opening 17 is 0%, and the air blowing ratio from the foot opening is 100%. At the position of the fixed bi-level mode in FIG. 10, the air blowing ratio from the face opening 17 is about 60%, and the air blowing ratio from the foot opening 18 is about 40%. On the ordinate in a direction from the position of the foot mode to the position of the fixed bi-level mode in FIG. 10, the air blowing ratio from the face opening 17 increases, and the air blowing ratio from the foot opening 18 reduces.

The abscissa of FIG. 10 shows the operation time of the warming-up control in the automatic control of the rear air conditioning unit 1. Generally, the warming-up control is performed at a heating-operation start in the winter. In the warming-up control, when the water temperature Tw is equal to or lower than the predetermined low temperature, operation of the blower 7 is stopped to prevent cool air from being blown into the passenger compartment. Then, when the hot water temperature Tw becomes equal to or higher than the predetermined low temperature (e.g., 30° C.), the operation of the blower 7 is started. At this time, the foot mode is selected in accordance with the normal control performed based on the TAO, and is continued to an initial time of Zero on the abscissa in FIG. 10. When the conditions at steps S130, S140, S150 are satisfied, a timer time t1 starts from the initial time of Zero.

In FIG. 10, when the conditions at steps S130, S140, S150 are satisfied after the foot mode is performed, the first linear bi-level mode is started. Here, the first linear bi-level mode is started from a state where all of conditioned air is blown from the foot opening 18 while none air is blown from the face opening 17. That is, the first linear bi-level mode is started from the state in the foot mode. In the first linear bi-level mode, until the timer time t1 passes, the air blowing amount from the foot opening 18 is linearly reduced while the air blowing amount from the face opening 17 is linearly increased as the time passes. When the first linear bi-level mode is ended, the air blowing ratio from the face opening 17 is substantially 60%, and the air blowing ratio from the foot opening 18 is substantially 40%.

Then, the fixed bi-level mode is performed. In the fixed bi-level mode, the face-foot air blowing ratio from both the face opening 17 and the foot opening 18 at the end of the first linear bi-level mode is maintained until the timer time t2 passes. The second liner bi-level mode is started after the fixed bi-level mode is ended. In the second linear bi-level mode, until the timer time t3 passes, the air blowing amount from the foot opening 18 is linearly increased while the air blowing amount from the face opening 17 is linearly reduced as the time passes. Then, the foot mode is set again after the second linear bi-level mode is ended.

As shown in FIGS. 7, 8, the timer time t1 is fixed at two minutes and the timer time t2 is fixed at five minutes, respectively, in the outside air temperature Tam equal to or higher than 0° C. As the outside air temperature Tam reduces from 0° C. to −20° C., the timer time t1 is increased from two minutes to four minutes, and the timer time t2 is increased from five minutes to ten minutes, respectively. In the outside air temperature Tam equal to or lower than −20° C., the timer times t1, t2 are fixed at four minutes and ten minutes, respectively. That is, in the first embodiment, the timer times t1, t2 are changed in accordance with the outside air temperature Tam. Specifically, as the outside air temperature Tam reduces, the timer times t1, t2 are set longer. On the other hand, the timer time t3 is set shorter (e.g., 60 seconds) than the timer time t1. Generally, the first linear bi-level mode is performed, when the air blowing amount is increased as the hot water temperature Tw increases in an initial time of the warming-up control. On the other hand, the second linear bi-level mode is performed when the air blowing amount is reduced as the inside air temperature increases. When the air blowing ratio between the upper and lower sides is changed in a case where the air blowing amount is small, the change of the air blowing amount and the change of air-conditioning noise reduce, as compared with a case where the air blowing ratio between the upper and lower sides is changed when the air blowing amount is large. Accordingly, even if the timer time t3 is set shorter than the timer time t1, it can prevent uncomfortable feeling from being given to the passenger.

The timer times t1, t2 are changed in accordance with the outside air temperature Tam by the following reasons, respectively. Generally, when the outside air temperature Tam is low, the air temperature in the face duct 19 becomes near the outside air temperature Tam before the heating operation, and the air temperature in the face duct 19 is also low. Therefore, as the outside air temperature Tam reduces, the timer time t1 needs to be set longer. Thus, cool air in the face duct 19 can be gradually blown, thereby restricting uncomfortable feeling from being given to the passenger. Further, as the outside air temperature Tam reduces, the timer time t2 needs to be set longer. Thus, in the fixed bi-level mode, warm air can be blown to the entire body of the passenger including the upper half body and the foot portion of the passenger for a longer time as the outside air temperature becomes lower.

The first linear bi-level mode is only a transient mode from the foot mode to the fixed bi-level mode in the warming-up control. On the other hand, the fixed bi-level mode is performed for warming the entire body of the passenger and for improving heating feeling of the passenger. Accordingly, as shown in FIGS. 7, 8, the timer time t2 is set longer than the timer time t1 in the first embodiment.

### Second Embodiment

The second embodiment of the present invention will be now described with reference to FIG. 11. In the second embodiment, the following two points are different from the first embodiment. First, as shown in FIG. 11, the linear bi-level mode (i.e., first linear bi-level mode in the first embodiment) starts from an air distribution state where the air blowing ratio from the face opening 17 is about 85% and the air blowing ratio from the foot opening 18 is about 15%. Secondly, the air outlet mode is directly switched from the fixed bi-level mode to the foot mode, without the above-described second linear bi-level mode. Even in this case, because the linear bi-level mode where the air blowing ratio between the upper and lower sides is gradually changed at the switching time from the foot mode to the fixed bi-level mode, the heating feeling given to the passenger in the warming-up control can be improved. In the second embodiment, the other parts are similar to those of the above-described first embodiment.

### Third Embodiment

The third embodiment of the present invention will be now described with reference to FIG. 12. In the third embodiment, as shown in FIG. 12, a first fixed bi-level mode BI(F1) is performed in place of the first linear bi-level mode of the above-described first embodiment. Thereafter, a second fixed bi-level mode BI(F2) is performed in place of the fixed bi-level mode of the above-described first embodiment. In the first fixed bi-level mode BI(F1), the air blowing ratio from the face opening 17 is about 85%, and the air blowing ratio from the foot opening 18 is about 15%. Further, the face-foot air blowing ratio between the upper and lower sides in the second fixed bi-level mode is identical to that in the fixed bi-level mode of the first embodiment.

According to the third embodiment, the first fixed bi-level mode BI(F1) is performed for a predetermined time t1 between the foot mode and the second fixed bi-level mode BI(F2), while the rear air outlet mode is changed from the foot mode to the second fixed bi-level mode BI(F2). Therefore, it can restrict the air flow ratio blown toward the face portion from being greatly suddenly increased.

### Fourth Embodiment

The fourth embodiment of the present invention will be now described with reference to FIG. 13. In the first embodiment, as shown in FIG. 10, the face-foot air blowing ratio in each of the first and second liner bi-level mode is linearly changed as time passes. However, in the fourth embodiment, as shown in FIG. 13, the face-foot air blowing ratios are stepwise changed between the foot mode and the fixed bi-level mode. Even in this case, the effect similar to the first embodiment can be obtained. Further, the face-foot air blowing ratio in one of the first and second linear bi-level modes of the first embodiment, in the linear bi-level mode of the second embodiment or in the linear bi-level mode of the third embodiment can be stepwise changed. Even in this case, the effect similar to the linear bi-level mode can be obtained.

### Fifth Embodiment

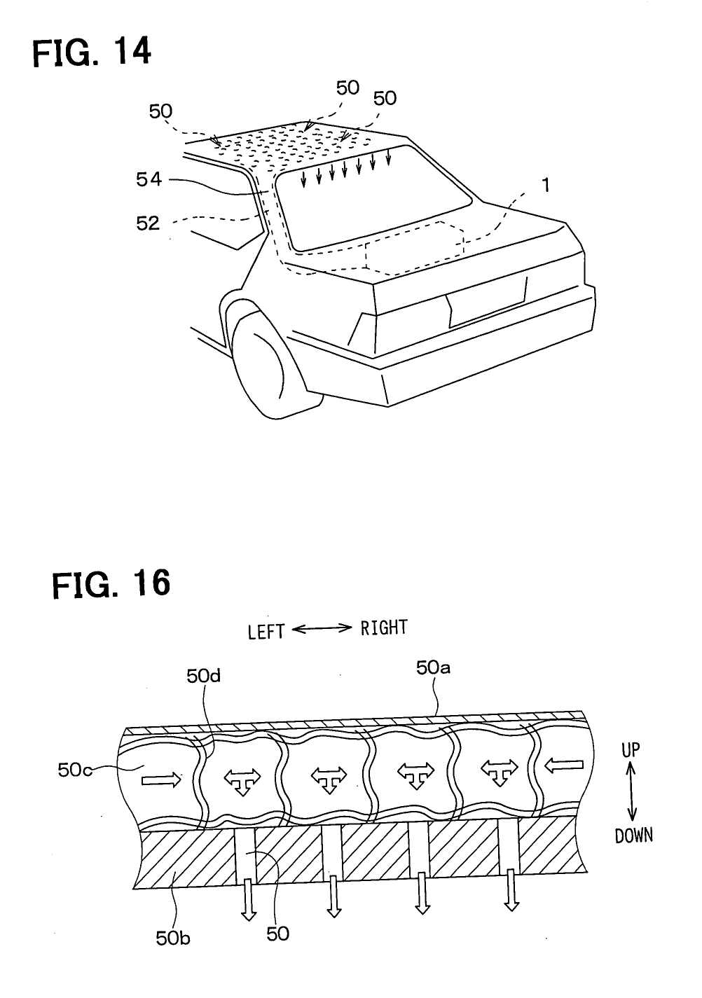

The fifth embodiment of the present invention will be now described with reference to FIGS. 14-16.

In the above-described first to fourth embodiments, the face outlets 19b are provided partially only on upper portions above the vehicle side windshields. Therefore, in the first linear bi-level mode, relatively high-speed conditioned air is partially blown from the upper portions to only a port of the upper half body of the passenger. Thus, high-speed air feeling (cool air feeling) may be given to only the port of the upper half body. In the fixed bi-level mode, after the conditioned air blown from the upper portions is entirely changed to warm air, the warm air is blown to only the port of the upper half body. Therefore, only the port of the upper half body is warmed. In this case, hot feeling may be given to only the port of the upper half body. Thus, although the other port of the upper half body is not sufficiently warmed, the air outlet mode may be switched from the fixed bi-level mode to the foot mode.

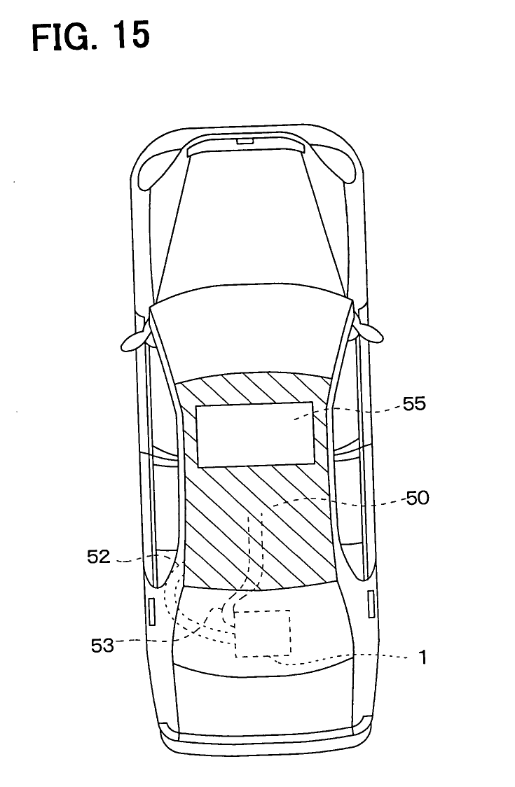

In the fifth embodiment, uncomfortable feeling due to conditioned air, partially blown from the upper portions to the upper half body of the passenger, can be restricted. As shown in FIG. 14, plural ceiling air outlets 50 are provided in the vehicle ceiling in the passenger compartment, and the rear air-conditioning unit 1 for blowing conditioned air into the plural ceiling air outlets 50 is disposed below a rear tray. The rear air-conditioning unit 1 is connected to one end of a pillar duct 52 and one end of a foot duct 53 shown in FIG. 15, and blows conditioned air into the passenger compartment through the ducts 52, 53. The pillar duct 52 is provided in a C pillar portion 54, to extend along the C pillar 54 toward the vehicle ceiling. The other end of the pillar duct 52 is connected to a ceiling air passage 50c shown in FIG. 16. The foot duct 53 is provided at a back side of the rear seat, to face the foot portion of the passenger. The foot outlets are provided at the other end area of the foot duct 53.

As shown in FIG. 16, the ceiling air outlets 50 have a three-dimension structure. A heat-insulating sheet 50a is disposed on an opposite side of a vehicle roof (not shown), and is made of a resin material having high heat-insulating performance and high sealing performance. A ceiling base member 50b is disposed below the heat-insulating sheet 50a while being separated from the heat-insulating sheet 50a by a predetermined clearance. The ceiling base member 50b has a thickness that is sufficiently thicker than a thickness of the heat-insulating sheet 50a, and is made of a resin material. The ceiling air passage 50c through which air flows is provided along the vehicle ceiling between the heat-insulating sheet 50a and the ceiling base member 50b, in a flat shape.

As shown in FIG. 15, in the fifth embodiment, the present invention is applied to a vehicle having a sunroof opening 55 in the vehicle ceiling at a vehicle front side. Here, the sunroof opening 55 has a rectangle shape elongated in a vehicle right-left direction. The ceiling air passage 50c is provided as indicated by a slant-line area in FIG. 15 so as to surround the sunroof opening 55. In an entire area of the ceiling air passage 50c, a three-dimension air passage structure 50d having a three-dimension fine passage shape is disposed.

Specifically, the three-dimension air passage structure 50d is constructed as a knit fabric structure (net structure) of a fiber member. The three-dimension air passage structure 50d is fixed to the ceiling base member 50b using an adhesive or a mechanically fastening member. Alternatively, the three-dimension air passage structure 50d may be sandwiched between the heat-insulating sheet 50a and the ceiling base member 50b to be fixed therebetween. The peripheral portion of the heat-insulating sheet 50a is airtightly fixed to the ceiling base member 50b using an adhesive while the three-dimension air passage structure 50d is inserted therebetween. Thus, the peripheral portion of the ceiling air passage 50c is sealed airtightly. In the ceiling base member 50b, the plural ceiling air outlets 50 each having a square shape are provided in an entire area of the ceiling air passage 50c. Accordingly, conditioned air is blown from the plural ceiling air outlets 50 toward the lower side in the passenger compartment. That is, the slant-line area in FIG. 15 indicates not only a forming area of the ceiling air passage 50c but also a forming area of the plural ceiling air outlets 50.

Next, operational effects and advantages according to the fifth embodiment will be described. In the fifth embodiment, the ceiling air passage 50c is provided substantially in the entire area of the ceiling portion in the passenger compartment except for the sunroof opening 55, and the plural ceiling outlets 50 are provided on a bottom portion of the ceiling air passage 50c. Therefore, conditioned air, having a uniform and low speed, is blown from the ceiling portion in a wide area of the passenger compartment so as to surround the upper half body of the passenger. Accordingly, mild and comfortable air-conditioning feeling is given to the passenger. Further, because conditioned air is blown so as to surround the upper half body of the passenger, hot feeling is not given to only a part of the upper half body of the passenger. Therefore, it is unnecessary to switch the air outlet mode from the fixed bi-level mode to the foot mode before sufficient heating feeling is given to the passenger, thereby improving heating feeling given to the passenger.

### Other Embodiments

Although the present invention has been fully described in connection with the preferred embodiments thereof with reference to the accompanying drawings, it is to be noted that various changes and modifications will become apparent to those skilled in the art.

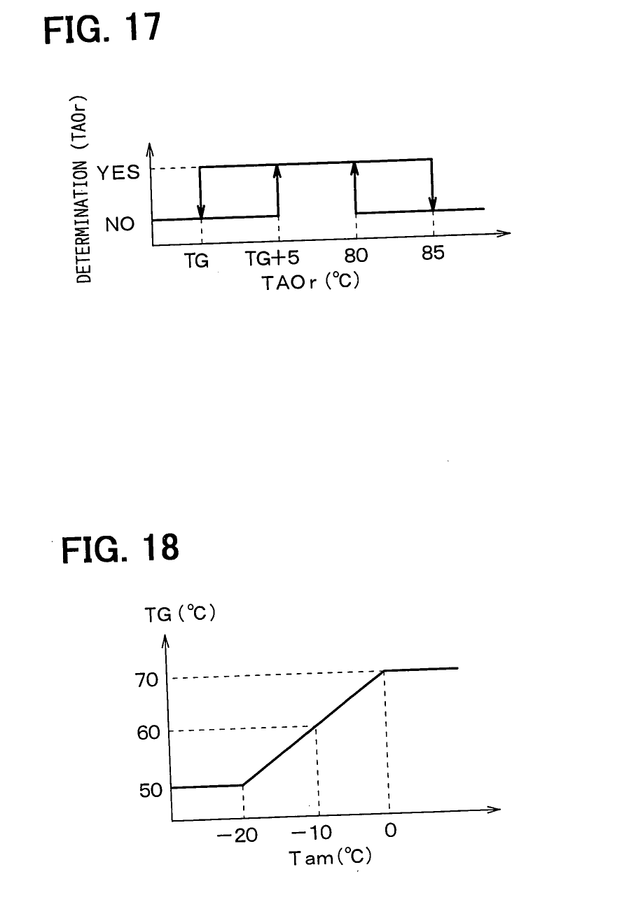

For example, in the above-described embodiments, the determination at step S150 shown in FIG. 3 is performed based on the fixed threshold temperatures (e.g., 60° C., 80° C. in FIG. 6). However, as shown in FIGS. 17, 18, a threshold temperature TG can be changed in accordance with the outside air temperature Tam. Generally, when the outside air temperature Tam is low, warm air is desired to be blown to the whole body of the passenger for a longtime. Accordingly, in this case, the air-conditioning feeling given to the passenger can be improved. FIG. 17 plots the rear target blowing temperature TAOr as the abscissa and the determination (YES, NO) of the rear target blowing temperature TAOr at step S150 in FIG. 3 as the ordinate. In FIG. 17, the threshold temperatures are set to have a hysteresis width of 5° C. in order to prevent hunting in the air-outlet mode control. The threshold temperature TG is obtained from a relationship with the outside air temperature Tam, as shown in FIG. 18. FIG. 18 plots the outside air temperature Tam as the abscissa and the threshold temperature TG as the ordinate.

The present invention can be applied to a warming-up control of a front air-conditioning unit, without being limited to the warming-up control of the rear air-conditioning unit 1 in the first to fifth embodiments. Further, a rotary door may be used as a mode switching member, in place of the slide-type air-outlet mode switching door 15, for selectively opening and closing the air outlet openings 17, 18, in the first to fifth embodiments.

In the above-described first embodiment, as shown in FIG. 10, the fixed bi-level mode, the second liner bi-level mode and the foot mode are performed in this order as the time passes. However, the second linear bi-level mode may be eliminated in the first embodiment. In this case, the foot mode is performed directly after the fixed bi-level mode is performed.

In the above-described second embodiment, as shown in FIG. 11, the rear air outlet mode is directly switched from the fixed bi-level mode to the foot mode. However, without being limited to this manner, the second linear bi-level mode shown in FIG. 10 may be performed between the fixed bi-level mode and the foot mode.

In the first and second linear bi-level modes and the linear bi-level mode according to the first, second, third and fifth embodiments, the face-foot air blowing ratio is linearly changed as the time passes. However, without being limited to this manner, the face-foot air blowing ratio may be changed along a convexly or concavely curved line as the time passes.

Plural pillar ducts may be provided without being limited to the single pillar duct 52 in the fifth embodiment. In this case, the conditioned air is blown from the plural pillar ducts into the ceiling air passage 50c.

In the fifth embodiment, the ceiling air passage 50c is provided so as to directly surround the sunroof opening 55. However, actually, a sunroof opening-closing member (not shown), for opening and closing the sunroof opening 55, is mounted on the ceiling portion in the passenger compartment slidably on the sunroof opening 55 in a vehicle front-rear direction. In this way, when the sunroof opening 55 is opened, the sunroof opening-closing member is placed at a vehicle rear side of the sunroof opening 55. Therefore, the ceiling air passage 50c may be provided so as to surround both of the sunroof opening 55 and a slide area of the sunroof opening-closing member. Even in this case, the ceiling air passage 50c may be provided substantially in a rectangular shape in an area except for the sunroof opening 55 and the slide area of the sunroof opening-closing member.

Such changes and modifications are to be understood as being within the scope of the present invention as defined by the appended claims.

What is claimed is:

1. An air conditioner for a vehicle, comprising:
an air-conditioning case for defining an air passage through which air flows into a passenger compartment, the air-conditioning case having a foot opening from which air is blown toward a lower portion in the passenger compartment, and a face opening from which air is blown toward an upper portion in the passenger compartment;
a blower for blowing air in the air passage into the passenger compartment at least through the foot opening and the face opening;
a heating heat exchanger, disposed in the air-conditioning case upstream from the foot opening and the face opening, for heating air blown by the blower;
a mode switching member f or opening and closing the face opening and the foot opening, to set at least a foot mode where the mode switching member closes the face opening and opens the foot opening, a fixed bi-level mode where the mode switching member opens both of the face opening and the foot opening by a predetermined fixed air-blowing ratio between air blown from the face opening and air blown from the foot opening, and a linear bi-level mode where an air blowing ratio from the foot opening is reduced and an air blowing ratio from the face opening is increased as a time passe; and
a control unit for controlling operation of the mode switching member,
wherein the control unit controls the mode switching member to perform the foot mode, the linear bi-level mode and the fixed bi-level mode in this order as the time passes in a warming-up control in which a temperature of air to be blown into the passenger compartment is increased by the heating heat exchanger after a start of a heating operation for heating the passenger compartment.

2. The air conditioner according to claim 1, wherein
the linear bi-level mode is started from a state in the foot mode.

3. The air conditioner according to claim 1, wherein
the linear bi-level mode is started from a state in which air is blown mainly from the foot opening while air is blown from the face opening by an air blowing ratio smaller than a predetermined ratio.

4. The air conditioner according to claim 1, wherein:
the mode switching member is disposed to further set an another linear bi-level mode in which the air blowing ratio from the foot opening is increased while the air blowing ratio from the face opening is reduced, as compared with the fixed bi-level mode, as the time passes; and
the control unit controls the mode switching member to perform the another linear bi-level mode and the foot mode in this order after the fixed bi-level mode is performed.

5. The air conditioner according to claim 4, wherein
the control unit performs one of the linear bi-level mode, the another linear bi-level mode and the fixed bi-level mode for a predetermined time that is set by a timer.

6. The vehicle air conditioner according to claim 4, wherein:
the control unit performs the linear bi-level mode for a first predetermined time, and performs the additional linear bi-level mode for a second predetermined time; and
the first predetermined time is longer than the second predetermined time.

7. The air conditioner according to claim 6, further comprising
an outside temperature sensor for detecting a temperature of outside air outside the passenger compartment;
wherein the first predetermined time and the second predetermined time are changed in accordance with the temperature of outside air.

8. The air conditioner according to claim 1, further comprising:
an air duct for defining a ceiling air passage into which air from the face opening is introduced, the ceiling air passage being provided along a ceiling portion in the passenger compartment, wherein:
the air duct has a lower portion having a plurality of ceiling air outlets from which air introduced into the ceiling air passage is blown downwardly into the passenger compartment.

9. The air conditioner according to claim 8, wherein
the ceiling air passage is provided substantially on an entire area of the ceiling portion.

10. An air conditioner for a vehicle, comprising:
an air-conditioning case for defining an air passage through which air flows into a passenger compartment of the vehicle, the air-conditioning case having a foot opening from which air is blown toward a lower portion in the passenger compartment, and a face opening from which air is blown toward an upper portion in the passenger compartment;
a blower for blowing air in the air passage into the passenger compartment at least through the foot opening and the face opening;
a heating heat exchanger, disposed in the air-conditioning case upstream from the foot opening and the face opening, for heating air blown by the blower;
a mode switching member for opening and closing the face opening and the foot opening, to set at least a foot mode where the mode switching member closes the face opening and opens the foot opening, a fixed bi-level mode where the mode switching member opens both of the face opening and the foot opening by a predetermined fixed air-blowing ratio between air blown from the face opening and air blown from the foot opening, and a linear bi-level mode where an air blowing ratio from the foot opening is increased and an air blowing ratio from the face opening is reduced as a time passes as compared with the fixed bi-level mode; and
a control unit for controlling operation of the mode switching member,
wherein the control unit controls the mode switching member to perform the foot mode, the fixed bi-level mode and the linear bi-level mode in this order as the time passes in a warming-up control in which a temperature of air to be blown into the passenger compartment is increased by the heating heat exchanger after a start of a heating operation for heating the passenger compartment.

11. The air conditioner according to claim 10, wherein the control unit performs the linear bi-level mode for a predetermined time that is set by a timer.

12. The air conditioner according to claim 11, wherein:
the fixed linear bi-level mode includes a first fixed bi-level mode in which air is blown mainly from the foot opening while air is blown from the face opening by an air blowing ratio smaller than a predetermined ratio, and a second fixed bi-level mode in which the air blowing ratio from the face opening is increased more than the predetermined ratio; and
the control unit performs the second fixed bi-level mode after the first fixed bi-level mode is performed.

13. The air conditioner according to claim 10, further comprising:
an air duct for defining a ceiling air passage into which air from the face opening is introduced, the ceiling air passage being provided along a ceiling portion in the passenger compartment, wherein:
the air duct has a lower portion having a plurality of ceiling air outlets from which air is blown downwardly into the passenger compartment.

14. The air conditioner according to claim 13, wherein
the ceiling air passage is provided substantially on an entire area of the ceiling portion.

15. The air conditioner according to claim 10, further comprising
an outside temperature sensor for detecting a temperature of outside air outside the passenger compartment, wherein:
the control unit performs the linear bi-level mode for a predetermined time; and
the predetermined time is changed in accordance with the temperature of outside air.

16. An air conditioner for a vehicle, comprising:
an air-conditioning case for defining an air passage through which air flows into a passenger compartment, the air-conditioning case having a foot opening from which air is blown toward a lower portion in the passenger compartment, and a face opening from which air is blown toward an upper portion in the passenger compartment;
a blower for blowing air in the air passage into the passenger compartment at least through the foot opening and the face opening;
a heating heat exchanger, disposed in the air-conditioning case upstream from the foot opening and the face opening, for heating air blown by the blower;
a mode switching member for opening and closing the face opening and the foot opening, to set at least a foot mode where the mode switching member closes the face opening and opens the foot opening, a fixed bi-level mode where the mode switching member opens both of the face opening and the foot opening by a predetermined fixed air-blowing ratio between air blown from the face opening and air blown from the foot opening, and a linear bi-level mode where an air blowing ratio from the foot opening and an air blowing ratio from the face opening are gradually changed as a time passe; and
a control unit for controlling operation of the mode switching member,
wherein the control unit controls the mode switching member to perform the linear bi-level mode between the foot mode and the fixed bi-level mode, in a warming-up control in which a temperature of air to be blown into the passenger compartment is increased by the heating heat exchanger after a start of a heating operation for heating the passenger compartment.
